(19) United States
(12) Patent Application Publication
(10) Pub. No.: US 2024/0163807 A1
(43) Pub. Date: May 16, 2024

(54) TECHNIQUES FOR POWER AMPLIFIER BACKOFF ADAPTATION COORDINATION

(71) Applicant: Qualcomm Incorporated, San Diego, CA (US)

(72) Inventors: Konstantinos DIMOU, New York, NY (US); Jianghong LUO, Skillman, NJ (US); Junyi LI, Fairless Hills, PA (US); Igor GUTMAN, Hod HaSharon (IL)

(21) Appl. No.: 18/454,544

(22) Filed: Aug. 23, 2023

Related U.S. Application Data
(60) Provisional application No. 63/383,867, filed on Nov. 15, 2022.

(51) Int. Cl. H04W 52/24

(52) U.S. Cl. CPC H04W 52/24

(57) ABSTRACT

Various aspects of the present disclosure generally relate to wireless communication. In some aspects, a first network node may receive resource status information associated with a second network node. The first network node may perform a power amplifier backoff adaptation based on the resource status information. Numerous other aspects are described.

### CROSS-REFERENCE TO RELATED APPLICATION

This patent application claims priority to U.S. Provisional Patent Application No. 63/383,867, filed on Nov. 15, 2022, entitled “TECHNIQUES FOR POWER AMPLIFIER BACKOFF ADAPTATION COORDINATION” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for power amplifier backoff adaptation coordination.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a first network node for wireless communication. The first network node may include one or more memories and one or more processors coupled to the one or more memories. The one or more processors may be individually or collectively configured to cause the first network node to receive resource status information associated with a second network node. The one or more processors may be individually or collectively configured to cause the first network node to perform a power amplifier backoff adaptation based on the resource status information.

Some aspects described herein relate to a second network node for wireless communication. The second network node may include one or more memories and one or more processors coupled to the one or more memories. The one or more processors may be individually or collectively configured to cause the second network node to detect an occurrence of a trigger condition for providing resource status information associated with a power amplifier backoff adaptation corresponding to a first network node. The one or more processors may be individually or collectively configured to cause the second network node to transmit the resource status information based on the occurrence of the trigger condition.

Some aspects described herein relate to a method of wireless communication performed by a first network node. The method may include receiving resource status information associated with a second network node. The method may include performing a power amplifier backoff adaptation based on the resource status information.

Some aspects described herein relate to a method of wireless communication performed by a second network node. The method may include detecting an occurrence of a trigger condition for providing resource status information associated with a power amplifier backoff adaptation corresponding to a first network node. The method may include transmitting the resource status information based on the occurrence of the trigger condition.

Some aspects described herein relate to a non-transitory computer-readable medium that stores a set of instructions for wireless communication by a first network node. The set of instructions, when executed by one or more processors of the first network node, may cause the first network node to receive resource status information associated with a second network node. The set of instructions, when executed by one or more processors of the first network node, may cause the first network node to perform a power amplifier backoff adaptation based on the resource status information.

Some aspects described herein relate to a non-transitory computer-readable medium that stores a set of instructions for wireless communication by a second network node. The set of instructions, when executed by one or more processors of the second network node, may cause the second network node to detect an occurrence of a trigger condition for providing resource status information associated with a power amplifier backoff adaptation corresponding to a first network node. The set of instructions, when executed by one or more processors of the second network node, may cause the second network node to transmit the resource status information based on the occurrence of the trigger condition.

Some aspects described herein relate to an apparatus for wireless communication. The apparatus may include means for receiving resource status information associated with a network node. The apparatus may include means for performing a power amplifier backoff adaptation based on the resource status information.

Some aspects described herein relate to an apparatus for wireless communication. The apparatus may include means for detecting an occurrence of a trigger condition for providing resource status information associated with a power amplifier backoff adaptation corresponding to a network node. The apparatus may include means for transmitting the resource status information based on the occurrence of the trigger condition.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of power amplifier backoff adaptation, in accordance with the present disclosure.

FIG. 5 is a diagram illustrating an example associated with power amplifier backoff adaptation coordination, in accordance with the present disclosure.

FIG. 6 is a diagram illustrating an example process performed, for example, by a first network node, in accordance with the present disclosure.

FIG. 7 is a diagram illustrating an example process performed, for example, by a second network node, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

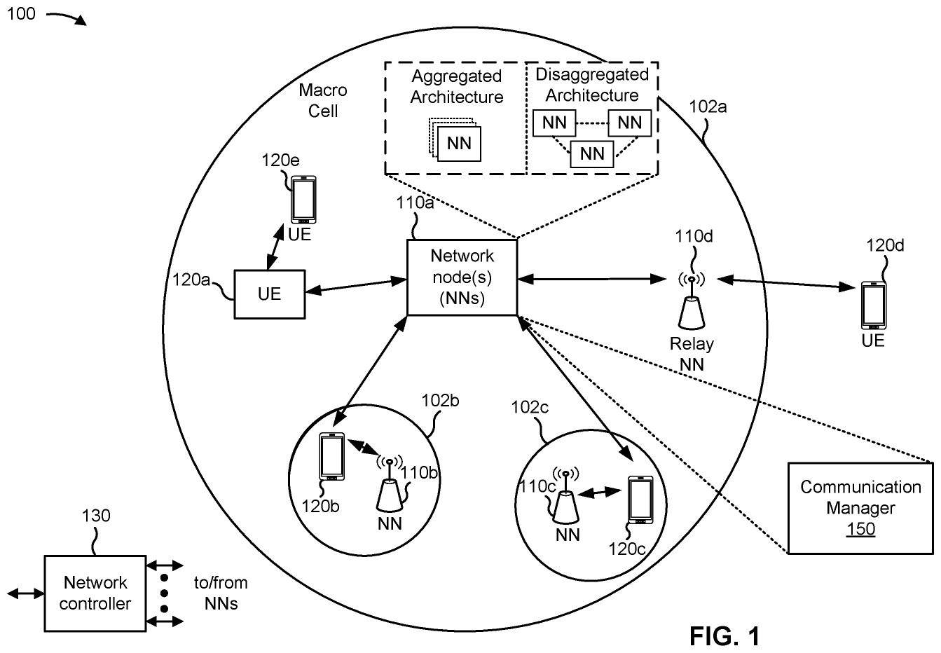

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the network node 110 may be a first network node and may include a communication manager 150. As described in more detail elsewhere herein, the communication manager 150 may receive resource status information associated with a second network node; and perform a power amplifier backoff adaptation based on the resource status information. In some aspects, the network node 110 may be a second network node and the communication manager 150 may detect an occurrence of a trigger condition for providing resource status information associated with a power amplifier backoff adaptation corresponding to a first network node; and transmit the resource status information based on the occurrence of the trigger condition. Additionally, or alternatively, the communication manager 150 may perform one or more other operations described herein.

As indicated above, FIG. 1 is provided as an example. Other examples may differ from what is described with regard to FIG. 1.

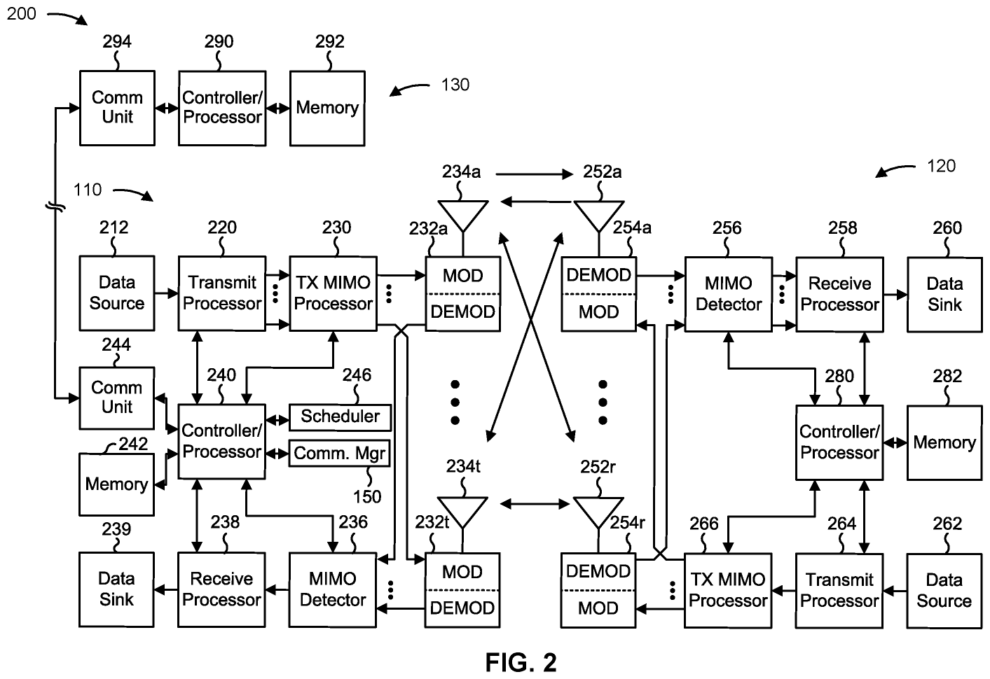

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

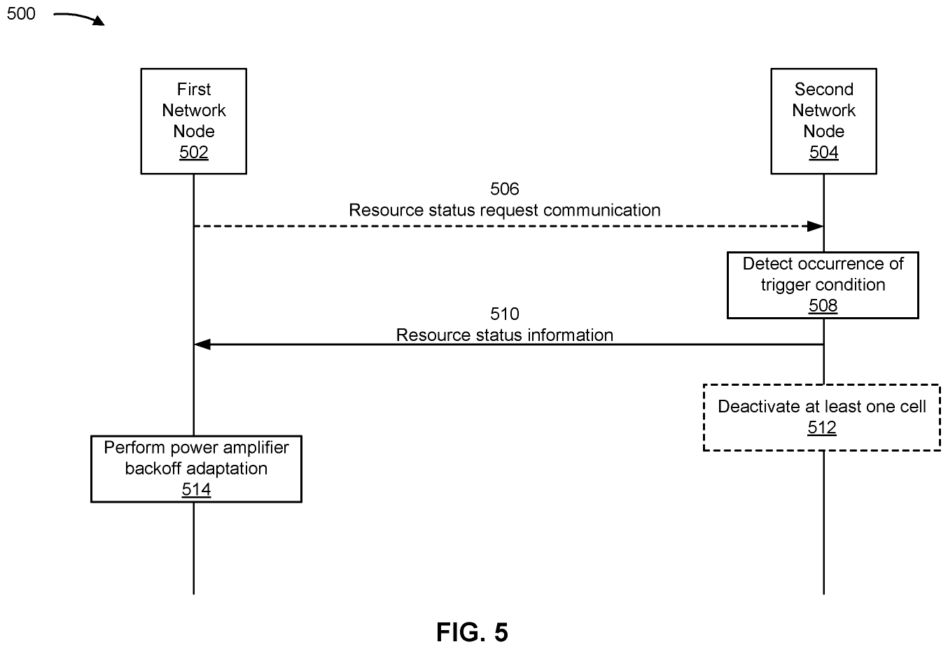

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 5-8).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 5-8).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

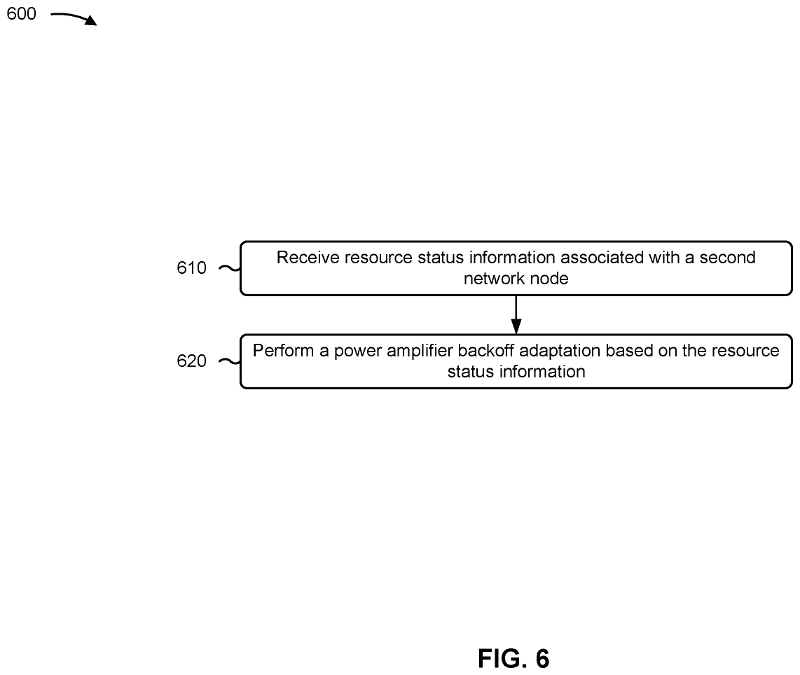

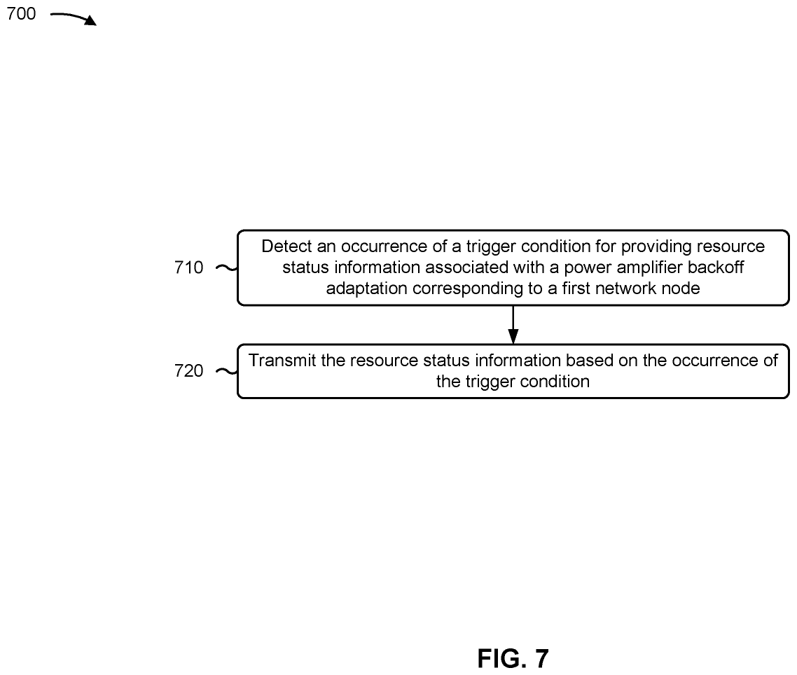

The controller/processor 240 of the network node 110, the controller/processor 280 of the UE 120, or any other component(s) of FIG. 2 may perform one or more techniques associated with power amplifier backoff adaptation coordination, as described in more detail elsewhere herein. For example, the controller/processor 240 of the network node 110, the controller/processor 280 of the UE 120, or any other component(s) (or combinations of components) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a first network node (e.g., the network node 110) includes means for receiving resource status information associated with a second network node; and/or means for performing a power amplifier backoff adaptation based on the resource status information. In some aspects, a second network node (e.g., the network node 110) includes means for detecting an occurrence of a trigger condition for providing resource status information associated with a power amplifier backoff adaptation corresponding to a first network node; and/or means for transmitting the resource status information based on the occurrence of the trigger condition. The means for the first network node and/or the second network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

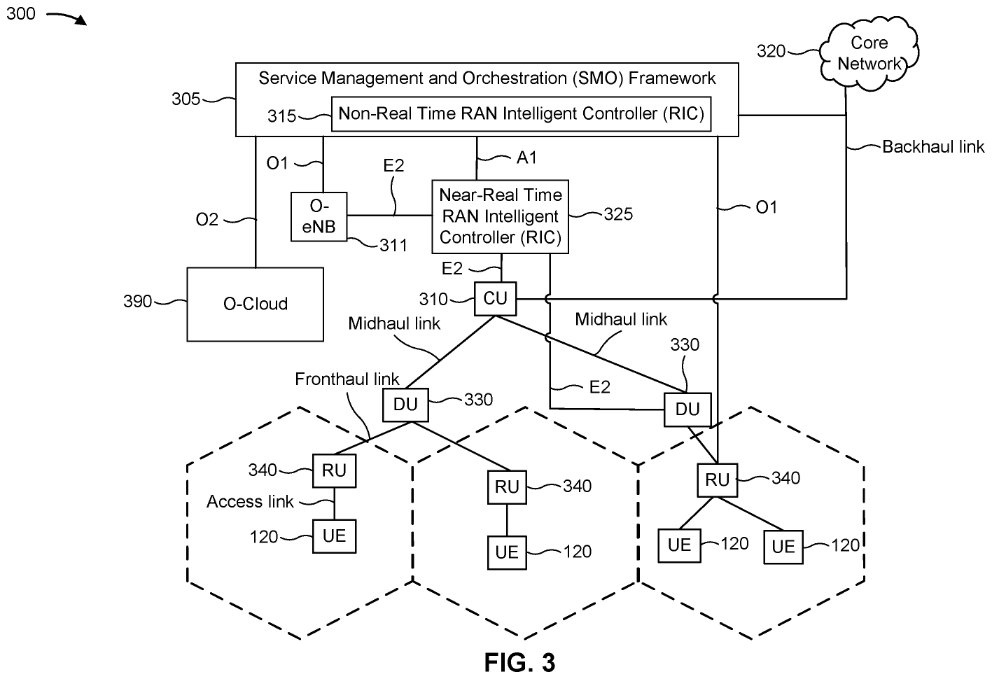

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

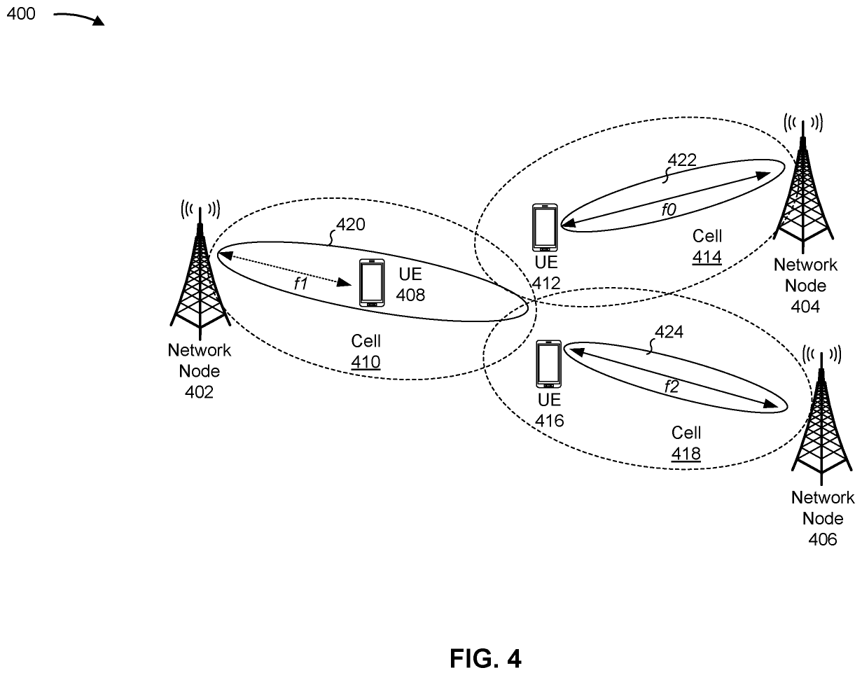

FIG. 4 is a diagram illustrating an example 400 of power amplifier backoff adaptation, in accordance with the present disclosure. As shown in FIG. 4, example 400 includes a first network node 402, a second network node 404, a third network node 406, a first UE 408 (e.g., in a coverage area corresponding to a cell 410 provided by the first network node 402), a second UE 412 (e.g., in a coverage area corresponding to a cell 414 provided by the second network node 404), and a third UE 416 (e.g., in a coverage area corresponding to a cell 418 provided by the third network node 406). In some examples, any two or more of the network nodes 402, 404, and/or 406 may be associated with the same operator, for example, and can coordinate measurements and/or power control. In some aspects, one or more of the network nodes 402, 404, and 406 may be, be similar to, include, or be included in, the network node 110 depicted in FIGS. 1 and 2 and/or one or more components of the disaggregated base station architecture 300 depicted in FIG. 3. In some aspects, one or more of the UEs 408, 412, and 416 may be, be similar to, include, or be included in, the UE 120 depicted in FIGS. 1-3.

As shown, the network node 402 can communicate with the UE 408 via a beam 420, the network node 404 can communicate with the UE 412 via a beam 422, and the network node 406 can communicate with the UE 416 via a beam 424. In some cases, the network node 402 can communicate with the UE 408 on a frequency f1, the network node 404 can communicate with the UE 412 on a frequency f0, and the network node 406 can communicate with the UE 416 on a frequency f2. In some cases, f1 can cause adjacent channel interference on frequencies f0 and f2, which are adjacent to f1, and the network node 402 can perform a power control procedure to mitigate the interference. An adjacent frequency can include a frequency that is contiguous to another frequency, has an index consecutive with another frequency, or is within a threshold range of another frequency. For example, f0 can be contiguous to f1. In another example, f0 can have a first frequency index and f1 can have a second frequency index that is consecutive to the first frequency index. In another example, f0 can be within a threshold wavelength range of f1. In another example, an adjacent channel can be any channel that is subject to adjacent channel interference (ACI) from f1.

In some examples, to perform a power control procedure, the network node 402 can perform power backoff relaxation or power supply reduction. For example, the network node 402 can reconfigure a power supplied to a power amplifier to reduce a transmit power from an antenna being controlled by the power amplifier. This can allow the network node 402 to increase an efficiency of the power amplifier, by reducing an amount of transmit power suppression that is applied to a transmit signal to ensure that the transmit signal does not exceed a threshold signal strength and cause interference. For example, for some network nodes 402, reducing an input voltage supply (e.g., backing off) by half, the power amplifier energy consumption is reduced to approximately 3 decibels (dB), which halves network energy usage. Applying power amplifier backoff can reduce an adjacent channel leakage ratio (ACLR) by approximately 10 dB and can increase an error vector magnitude (EVM) by approximately 8 dB. Because power amplifier energy consumption can be a majority of overall power consumption by a network node, halving the backoff of a power amplifier can reduce a total network node 402 energy consumption by approximately 35%. In some cases, the network node 402 can back off a power amplifier, such that neither out-of-band nor in-band unwanted emissions are generated.

In some cases, the network node 402 can modify the power amplifier backoff by performing a power amplifier backoff adaptation. For example, the network node 402 can reduce a power amplifier backoff, thereby increasing a power output from the power amplifier. For example, the network node 402 can perform a power amplifier backoff adaptation in cases in which there is low load (e.g., few or no connected UEs) associated with the cell 410, the cell 414, and/or the cell 418. However, reducing a power backoff by performing a power amplifier backoff can result in unwanted in-band and out-of-band emissions, and therefore can result in interference to the UE 412, the UE 416, the network node 404, the network node 406, the cell 414, the cell 418, the beam 422, the beam 424, the frequency f0, and/or the frequency f2. In some cases, if the network node 402 is unaware of an affected UE, an affected frequency, an affected cell, and/or an affected beam, the network node 402 can cause disruptive interference to the affected UE, the affected frequency, the affected cell, and/or the affected beam, thereby negatively impacting network performance.

Some aspects of the techniques and apparatuses described herein may facilitate network node power amplifier backoff adaptation while mitigating the risk of causing interference associated with neighboring cells. In some aspects, for example, a second network node may detect an occurrence of a trigger condition for providing resource status information associated with a power amplifier backoff adaptation corresponding to a first network node. The second network node may transmit the resource status information based on the occurrence of the trigger condition. Based on receiving the resource status information, the first network node may perform the power amplifier backoff adaptation. The resource status information may indicate an acceptance by the second network node associated with the power backoff adaptation and may, in some aspects, include information associated with one or more time resources and/or frequency resources associated with a rejection of the power amplifier backoff adaptation. In this way, the first network node may coordinate with the second network node (and/or any number of additional network nodes) to facilitate a power amplifier backoff adaptation while mitigating risk of interference associated with communications of the second network node.

In some aspects, the trigger condition may include receiving a resource status request communication from the first network node. In this way, overhead associated with transmitting resource status information may be avoided except in cases in which the first network node intends to perform the power amplifier backoff adaptation. In some aspects, detecting the occurrence of the trigger condition may include detecting that no UEs are connected to a cell of the second network node. In this way, overhead associated with transmission of a resource status request communication by the first network node may be avoided and resource status information may be transmitted only when conditions associated with network nodes neighboring the first network node may be appropriate for performance of power amplifier backoff adaptation by the first network node. In some aspects, the occurrence of the trigger condition may be an occurrence of a scheduled time for reporting resource status information. In this way, the first network node may periodically be informed of resource status information and may perform a power amplifier backoff adaptation when resource status information indicates an acceptance of the power amplifier backoff adaptation. Any number of other trigger conditions may be used to trigger transmission of the resource status information associated with the second network node.

In some cases, one or more of the network nodes 402, 404, and 406 may identify affected UEs, affected frequencies, affected beams, and/or affected cells. In the context of a power amplifier backoff adaptation performed by the network node 402, an affected UE is a UE that is susceptible to interference associated with the power amplifier backoff adaptation. The affected UE may be susceptible to the interference based on a frequency on which the UE communicates with a network node (e.g., network node 404 or 406). Similarly, an affected frequency is a frequency that is susceptible to interference associated with the power amplifier backoff adaptation, an affected beam is a beam that is susceptible to interference associated with the power amplifier backoff adaptation, and an affected cell is a cell that is susceptible to interference associated with the power amplifier backoff adaptation.

In some aspects, a network node may identify a UE, a frequency, a beam, and/or a cell as being an affected UE, frequency, beam, and/or cell based on determining a statistical likelihood, satisfying a likelihood threshold, that the UE, the frequency, the beam, and/or the cell will experience interference due to another network performing a power amplifier backoff adaptation. In some aspects, a network node may identify a UE, a frequency, a beam, and/or a cell as being an affected UE, frequency, beam, and/or cell based on determining an amount of interference experienced by the UE, the frequency, the beam, and/or the cell due to another network node communicating on a frequency. As an example, the network node 404 can configure the UE 412 to perform one or more interference measurements on f0 to determine an amount of interference on f0 from the network node 402 and the UE 408 communicating on f1. In another example, the network node 404 may configure the UE 412 to transmit one or more signals for the network node 404 to perform one or more interference measurements on f0. The UE 412 can perform one or more downlink interference measurements and report information associated with the one or more downlink interference measurements to the network node 404. For example, the UE 412 can report an interference level on f0 to the network node 404.

In some cases, the network node 404 can transmit resource status information indicating an extent to which the power control procedure (e.g., the power amplifier backoff adaptation) affected interference on f0. For example, the network node 404 may indicate to the network node 402 that the backoff adaptation increased the level of interference on f0 to more than a threshold level. The UE 412, the frequency f0, the cell 414, and/or the beam 422 may be determined, based on the interference exceeding the threshold level, to be an affected UE 412, an affected frequency, an affected cell 414, and/or an affected beam, respectively. In some cases, the UE 416, the frequency f2, the cell 418, and/or the beam 424 can be similarly determined to be an affected UE 416, and affected frequency, an affected cell 418, and/or an affected beam 424.

Based on the identification of the affected UEs, frequencies, cells, and/or beams, network nodes neighboring the network node 402 may provide resource status information to the network node 402 to facilitate power amplifier backoff adaptation.

As indicated above, FIG. 4 is provided as an example. Other examples may differ from what is described with respect to FIG. 4.

FIG. 5 is a diagram illustrating an example 500 associated with power amplifier backoff adaptation coordination, in accordance with the present disclosure. As shown in FIG. 5, example 500 includes communication between a first network node 502 and a second network node 504. In some aspects, first network node 502 and/or the second network node 504 may be, be similar to, include, or be included in, one or more of the network nodes 402, 404, and 406 depicted in FIG. 4, the network node 110 depicted in FIGS. 1 and 2, and/or one or more components of the disaggregated base station architecture 300 depicted in FIG. 3. In some aspects, the first network node 502 may be associated with a first operator and configured to communicate with a UE (e.g., the UE 120) on an assigned operating carrier frequency. The second network node 504 may be associated with a second operator and may communicate on one or more carrier frequencies adjacent to the assigned operating carrier frequency. In some aspects, the second network node 504 may be associated with the first operator. A first frequency may be adjacent to a second frequency when the first frequency is consecutive to the second frequency, contiguous to the second frequency, within a frequency range of the second frequency (e.g., allowing for a relatively small gap between “adjacent” frequencies), or is capable of being interfered with as a result of transmissions on the second frequency.

As shown by reference number 506, the first network node 502 may transmit a resource status request communication. In some aspects, the resource status request communication may include an indication associated with the power amplifier backoff adaptation. For example, the resource status request communication may indicate one or more aspects of an intended power amplifier backoff adaptation. In some aspects, the resource status request communication may indicate a time period corresponding to the power amplifier backoff adaptation. In some aspects, the time period may be indicated as an amount of time (e.g., a number of nanoseconds, microseconds, milliseconds, and/or seconds, among other examples) and/or at least one time resource (e.g., a number of symbols, slots, and/or frames, among other examples).

In some aspects, the resource status request communication may indicate at least one power amplifier backoff adaptation value associated with the power amplifier backoff adaptation. In some aspects, the at least one power amplifier backoff adaptation value may correspond to at least one respective time period. In some aspects, the indication of the power amplifier backoff adaptation pattern may indicate at least one beam associated with the power amplifier backoff adaptation. For example, the resource status request communication may indicate a TCI state associated with the power amplifier backoff adaptation.

In some aspects, the resource status request communication may include an indication of a power amplifier backoff adaptation pattern associated with the power amplifier backoff adaptation. In some aspects, the indication of the power amplifier backoff adaptation pattern may indicate a plurality of time resources associated with the power amplifier backoff adaptation. In some aspects, for example, the indication of the power amplifier backoff adaptation pattern may indicate power amplifier backoff adaptation information associated with at least one time resource position of a set of time resource positions. The set of time resource positions may include a pattern to be applied to at least one set of time resources. For example, the first network node 502 may know, in advance, of a number of slots during which the network node 502 is to perform the power amplifier backoff adaptation pattern and may indicate those slots (which may be referred to as “backoff adaptation slots” (BASs)), or a pattern corresponding to the slots, in the resource status request communication. For example, the set of time resource positions may include a first slot, a second slot, a fourth slot and a fifth slot of a seven slot pattern. Any number of other patterns and/or time resources may be indicated in accordance with the present disclosure. For example, in some aspects, the network node 502 may schedule a semi-persistent scheduling (SPS) communication corresponding to a pattern of slots and may intend to perform the power amplifier backoff adaptation in association with the SPS communication. The network node 502 may indicate the slot pattern corresponding to the SPS.

In some aspects, the indication of the power amplifier backoff adaptation pattern may indicate at least one power amplifier backoff adaptation value associated with the power amplifier backoff adaptation. In some aspects, the at least one power amplifier backoff adaptation value may correspond to at least one respective slot. For example, in some aspects, the power amplifier backoff adaptation pattern may indicate, for each BAS, a respective power amplifier backoff adaption value. In some aspects, the indication of the power amplifier backoff adaptation pattern may indicate at least one beam (e.g., TCI state) associated with the power amplifier backoff adaptation pattern.

As shown by reference number 508, the second network node 504 may detect an occurrence of a trigger condition. The trigger condition may be a trigger condition for providing resource status information associated with a power amplifier backoff adaptation corresponding to the first network node 502. In some aspects, the second network node 504 may detect the occurrence of the trigger condition based on receiving the resource status request communication. For example, the second network node 504 may detect the occurrence of the trigger condition by detecting reception of the resource status request communication and/or by detecting a change in a value of a trigger condition indicator (e.g., an indication stored in a memory of the network node 504), among other examples.

In some aspects, the second network node 504 may detect the occurrence of the trigger condition based on detecting that no UE is connected to an affected cell (e.g., an affected cell associated with the second network node 504). For example, the second network node 504 may detect the occurrence of the trigger condition by detecting that no UE is connected to the affected cell, by detecting a disconnection, from the affected cell, of a last UE to be connected to the affected cell, and/or by detecting a change in a value of a trigger condition indicator, among other examples. In some aspects, the second network node 504 may detect the occurrence of the trigger condition based on detecting deactivation of an affected cell (e.g., an affected cell associated with the second network node 504). For example, the second network node 504 may detect the occurrence of the trigger condition by detecting that the affected cell has been deactivated and/or by detecting a change in a value of a trigger condition indicator, among other examples. In some aspects, detecting that the affected cell has been deactivated may be inherent in deactivating the affected cell (e.g., the second network node 504 may detect deactivation of the affected cell by deactivating the affected cell). In some aspects, the second network node 504 may detect the occurrence of the trigger condition by detecting an occurrence of a trigger time, an expiration of a trigger timer, and/or an occurrence of a time resource, among other examples.

As shown by reference number 510, the second network node 504 may transmit, and the first network node 502 may receive, resource status information. The resource status information may be associated with the second network node 504. In some aspects, the resource status information may indicate an acceptance associated with the power amplifier backoff adaptation. The acceptance of the power amplifier backoff adaptation may be an approval of performance of the power amplifier backoff adaptation by the first network node 502. For example, the acceptance of the power amplifier backoff adaptation may include an indication to the first network node 502 that, at least from the perspective of the second network node 504, the first network node 502 may perform power amplifier backoff adaptation. In some aspects, the acceptance of the power amplifier backoff adaptation may be limited to one or more beams (e.g., TCI states), one or more frequencies, one or more time periods, and/or one or more UEs, among other examples.

For example, in some aspects, the resource status information may indicate at least one beam associated with the acceptance. In some aspects, the resource status information may indicate at least one beam associated with a rejection associated with the power amplifier backoff adaptation. For example, the resource status information may indicate one or more beams for which the power amplifier backoff adaptation is not approved. Similarly, in some aspects, the resource status information may indicate a rejection of the power amplifier backoff adaptation associated with one or more frequencies, one or more time periods, and/or one or more UEs, among other examples. In some aspects, the resource status information may indicate a cell deactivation associated with a duration associated with the power amplifier backoff adaptation. In some aspects, the network node 502 may receive additional resource status information associated with at least one additional network node.

As shown by reference number 512, the second network node 504 may deactivate at least one cell (e.g., at least one affected cell). In some aspects, the deactivation of the at least one cell may be the occurrence of the trigger event based on which the second network node 504 transmits the resource status information. In some aspects, the second network node 504 may deactivate the at least one cell based on transmission of the resource status information. In some aspects, the at least one cell may be associated with at least one beam associated with the power amplifier backoff adaptation. The at least one cell may be deactivated for a duration associated with the power amplifier backoff adaptation. In some aspects, as a consequence of, in addition to, or in lieu of, deactivating the at least one cell, the second network node 504 may refrain from scheduling a downlink communication corresponding to a beam, a frequency, and/or a UE associated with the power amplifier backoff adaptation.

As shown by reference number 514, the first network node 502 may perform the power amplifier backoff adaptation. In some aspects, the first network node 502 may perform the power amplifier backoff adaptation based on the resource status information. For example, the first network node 502 may perform the power amplifier backoff adaptation in response to receiving the resource status information. In some aspects, the first network node 502 may perform the power amplifier backoff adaptation based on the resource status information by performing the power amplifier backoff adaptation associated with one or more beams (e.g., TCI states) indicated in the resource status information, one or more frequencies indicated in the resource status information, one or more time periods indicated in the resource status information, and/or one or more UEs indicated in the resource status information, among other examples.

As indicated above, FIG. 5 is provided as an example. Other examples may differ from what is described with respect to FIG. 5.

FIG. 6 is a diagram illustrating an example process 600 performed, for example, by a first network node, in accordance with the present disclosure. Example process 600 is an example where the first network node (e.g., first network node 502) performs operations associated with techniques for power amplifier backoff adaptation coordination.

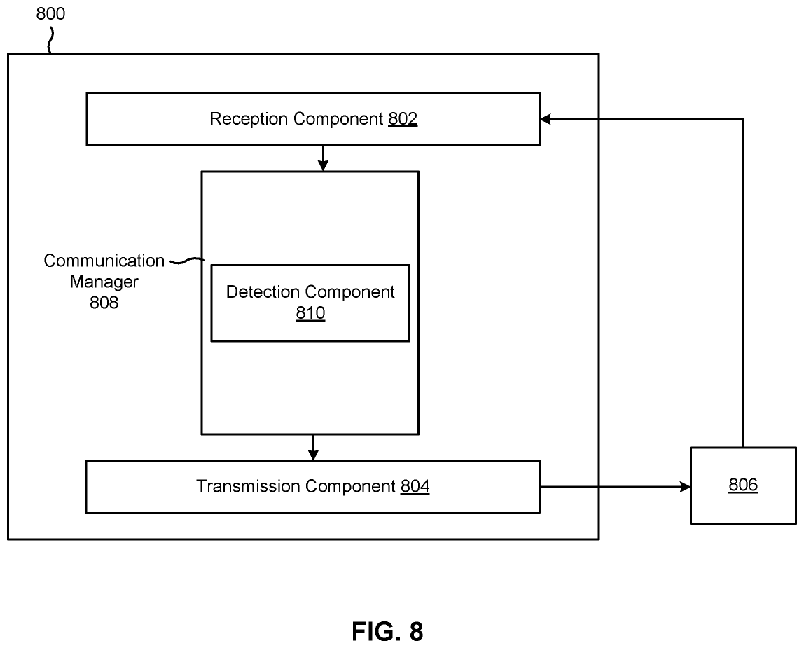

As shown in FIG. 6, in some aspects, process 600 may include receiving resource status information associated with a second network node (block 610). For example, the first network node (e.g., using communication manager 808 and/or reception component 802, depicted in FIG. 8) may receive resource status information associated with a second network node, as described above.

As further shown in FIG. 6, in some aspects, process 600 may include performing a power amplifier backoff adaptation based on the resource status information (block 620). For example, the first network node (e.g., using communication manager 808 and/or transmission component 804, depicted in FIG. 8) may perform a power amplifier backoff adaptation based on the resource status information, as described above.

Process 600 may include additional aspects, such as any single aspect or any combination of aspects described below and/or in connection with one or more other processes described elsewhere herein.

In a first aspect, process 600 includes transmitting a resource status request communication, wherein receiving the resource status information comprises receiving the resource status information based on the resource status request communication. In a second aspect, alone or in combination with the first aspect, the resource status request communication comprises an indication associated with the power amplifier backoff adaptation. In a third aspect, alone or in combination with one or more of the first and second aspects, the resource status request communication indicates a time period corresponding to the power amplifier backoff adaptation. In a fourth aspect, alone or in combination with one or more of the first through third aspects, the resource status request communication indicates at least one time resource corresponding to the power amplifier backoff adaptation.

In a fifth aspect, alone or in combination with one or more of the first through fourth aspects, the resource status request communication comprises an indication of a power amplifier backoff adaptation pattern associated with the power amplifier backoff adaptation. In a sixth aspect, alone or in combination with the fifth aspect, the indication of the power amplifier backoff adaptation pattern indicates a plurality of time resources associated with the power amplifier backoff adaptation. For example, the indication of the power amplifier backoff adaptation pattern may indicate power amplifier backoff adaptation information associated with at least one time resource position of a set of time resource positions, wherein the set of time resource positions comprises a pattern to be applied to at least one set of time resources. In a seventh aspect, alone or in combination with one or more of the fifth or sixth aspects, the indication of the power amplifier backoff adaptation pattern indicates at least one power amplifier backoff adaptation value associated with the power amplifier backoff adaptation. In an eighth aspect, alone or in combination with one or more of the fifth through seventh aspects, the indication of the power amplifier backoff adaptation pattern indicates at least one beam associated with the power amplifier backoff adaptation pattern. In a ninth aspect, alone or in combination with one or more of the first through eighth aspects, the resource status request communication indicates at least one beam associated with the power amplifier backoff adaptation.

In a tenth aspect, alone or in combination with one or more of the first through ninth aspects, the resource status information indicates an acceptance by the second network node that is associated with the power amplifier backoff adaptation. In an eleventh aspect, alone or in combination with the tenth aspect, the resource status information indicates at least one beam associated with the acceptance. In a twelfth aspect, alone or in combination with one or more of the tenth or eleventh aspects, the resource status information indicates at least one beam associated with a rejection by the second network node that is associated with the power amplifier backoff adaptation. In a thirteenth aspect, alone or in combination with one or more of the tenth through twelfth aspects, the resource status information indicates a cell deactivation associated with a duration associated with the power amplifier backoff adaptation.

In a fourteenth aspect, alone or in combination with one or more of the first through thirteenth aspects, process 600 includes receiving additional resource status information associated with at least one additional network node, wherein performing the power amplifier backoff adaptation comprises performing the power amplifier backoff adaptation based on the additional resource status information. In a fifteenth aspect, alone or in combination with one or more of the first through fourteenth aspects, performing the power backoff adaption includes reducing a power amplifier backoff associated with a power amplifier of the first network node.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a second network node, in accordance with the present disclosure. Example process 700 is an example where the second network node (e.g., second network node 504) performs operations associated with techniques for power amplifier backoff adaptation coordination.

As shown in FIG. 7, in some aspects, process 700 may include detecting an occurrence of a trigger condition for providing resource status information associated with a power amplifier backoff adaptation corresponding to a first network node (block 710). For example, the second network node (e.g., using communication manager 808 and/or detection component 810, depicted in FIG. 8) may detect an occurrence of a trigger condition for providing resource status information associated with a power amplifier backoff adaptation corresponding to a first network node, as described above.

As further shown in FIG. 7, in some aspects, process 700 may include transmitting the resource status information based on the occurrence of the trigger condition (block 720). For example, the second network node (e.g., using communication manager 808 and/or transmission component 804, depicted in FIG. 8) may transmit the resource status information based on the occurrence of the trigger condition, as described above.

Process 700 may include additional aspects, such as any single aspect or any combination of aspects described below and/or in connection with one or more other processes described elsewhere herein.

In a first aspect, detecting the occurrence of the trigger condition comprises receiving a resource status request communication. In a second aspect, alone or in combination with the first aspect, the resource status request communication comprises an indication associated with the power amplifier backoff adaptation. In a third aspect, alone or in combination with one or more of the first and second aspects, the resource status request communication indicates a time period corresponding to the power amplifier backoff adaptation. In a fourth aspect, alone or in combination with one or more of the first through third aspects, the resource status request communication indicates at least one time resource corresponding to the power amplifier backoff adaptation.

In a fifth aspect, alone or in combination with one or more of the first through fourth aspects, the resource status request communication comprises an indication of a power amplifier backoff adaptation pattern associated with the power amplifier backoff adaptation. In a sixth aspect, alone or in combination with the fifth aspect, the indication of the power amplifier backoff adaptation pattern indicates a plurality of time resources associated with the power amplifier backoff adaptation. In a seventh aspect, alone or in combination with one or more of the fifth or sixth aspects, the indication of the power amplifier backoff adaptation pattern indicates at least one power amplifier backoff adaptation value associated with the power amplifier backoff adaptation. In an eighth aspect, alone or in combination with one or more of the fifth through seventh aspects, the indication of the power amplifier backoff adaptation pattern indicates at least one beam associated with the power amplifier backoff adaptation pattern. In a ninth aspect, alone or in combination with one or more of the first through eighth aspects, the resource status request communication indicates at least one beam associated with the power amplifier backoff adaptation.

In a tenth aspect, alone or in combination with one or more of the first through ninth aspects, the resource status information indicates an acceptance by the second network node that is associated with the power amplifier backoff adaptation. In an eleventh aspect, alone or in combination with the tenth aspect, the resource status information indicates at least one beam associated with the acceptance. In a twelfth aspect, alone or in combination with the eleventh aspect, the resource status information indicates the at least one beam based on detecting that no UE is in connected status with the at least one beam. In a thirteenth aspect, alone or in combination with one or more of the eleventh or twelfth aspects, process 700 includes deactivating at least one cell associated with the at least one beam for a duration associated with the power amplifier backoff adaptation. In a fourteenth aspect, alone or in combination with the thirteenth aspect, the resource status information indicates a cell deactivation associated with the at least one cell for the duration. In a fifteenth aspect, alone or in combination with one or more of the tenth through fourteenth aspects, the resource status information indicates at least one beam associated with a rejection by the second network node that is associated with the power amplifier backoff adaptation.

In a sixteenth aspect, alone or in combination with one or more of the first through fifteenth aspects, process 700 includes refraining from scheduling a downlink communication corresponding to a beam associated with the power amplifier backoff adaptation. In a seventeenth aspect, alone or in combination with one or more of the first through sixteenth aspects, process 700 includes refraining from scheduling a downlink communication corresponding to a UE that is susceptible to interference associated with the power amplifier backoff adaptation. In an eighteenth aspect, alone or in combination with one or more of the first through seventeenth aspects, detecting the occurrence of the trigger condition comprises detecting that no UE is connected to a cell that is susceptible to interference associated with the power amplifier backoff adaptation. In a nineteenth aspect, alone or in combination with one or more of the first through eighteenth aspects, detecting the occurrence of the trigger condition comprises detecting deactivation of a cell that is susceptible to interference associated with the power amplifier backoff adaptation.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808. The communication manager 808 may include a detection component 810, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6, process 700 of FIG. 7, or a combination thereof. In some aspects, the apparatus 800 and/or one or more components shown in FIG. 8 may include one or more components of the network node described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the network node described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the network node described in connection with FIG. 2. In some aspects, the transmission component 804 may be co-located with the reception component 802 in a transceiver.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving, transmitting, performing, and/or detecting may include various processing system components, such as a receive processor, a transmit processor, a controller/processor, a memory, or a combination thereof, of the network node described above in connection with FIG. 2.

The communication manager 808 and/or the reception component 802 may receive resource status information associated with a second network node. In some aspects, the communication manager 808 may include one or more antennas, a modem, a controller/processor, a memory, or a combination thereof, of the network node described in connection with FIG. 2. In some aspects, the communication manager 808 may include the reception component 802 and/or the transmission component 804. In some aspects, the communication manager 808 may be, be similar to, include, or be included in, the communication manager 150 depicted in FIGS. 1 and 2.

The communication manager 808 and/or the transmission component 804 may perform a power amplifier backoff adaptation based on the resource status information. The communication manager 808 and/or the transmission component 804 may transmit a resource status request communication, wherein the resource status information is based on the resource status request communication. The communication manager 808 and/or the reception component 802 may receive additional resource status information associated with at least one additional network node, wherein performing the power amplifier backoff adaptation comprises performing the power amplifier backoff adaptation based on the additional resource status information.

The communication manager 808 and/or the detection component 810 may detect an occurrence of a trigger condition for providing resource status information associated with a power amplifier backoff adaptation corresponding to a first network node. In some aspects, the detection component 810 may include one or more antennas, a modem, a controller/processor, a memory, or a combination thereof, of the network node described in connection with FIG. 2. In some aspects, the detection component 810 may include the reception component 802 and/or the transmission component 804.

The communication manager 808 and/or the transmission component 804 may transmit the resource status information based on the occurrence of the trigger condition. The communication manager 808, the reception component 802, and/or the transmission component 804 may deactivate at least one cell associated with the at least one beam for a duration associated with the power amplifier backoff adaptation. The communication manager 808 and/or the transmission component 804 may refrain from scheduling a downlink communication corresponding to a beam associated with the power amplifier backoff adaptation. The communication manager 808 and/or the transmission component 804 may refrain from scheduling a downlink communication corresponding to an affected UE, the affected UE comprising a UE that is susceptible to interference associated with the power amplifier backoff adaptation.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a first network node, comprising: receiving resource status information associated with a second network node; and performing a power amplifier backoff adaptation based on the resource status information.

Aspect 2: The method of Aspect 1, further comprising transmitting a resource status request communication, wherein receiving the resource status information comprises receiving the resource status information based on the resource status request communication.

Aspect 3: The method of Aspect 2, wherein the resource status request communication comprises an indication associated with the power amplifier backoff adaptation.

Aspect 4: The method of either of Aspects 2 or 3, wherein the resource status request communication indicates a time period corresponding to the power amplifier backoff adaptation.

Aspect 5: The method of any of Aspects 2-4, wherein the resource status request communication indicates at least one time resource corresponding to the power amplifier backoff adaptation.

Aspect 6: The method of any of Aspects 2-5, wherein the resource status request communication comprises an indication of a power amplifier backoff adaptation pattern associated with the power amplifier backoff adaptation.

Aspect 7: The method of Aspect 6, wherein the indication of the power amplifier backoff adaptation pattern indicates a plurality of time resources associated with the power amplifier backoff adaptation.

Aspect 8: The method of either of claim 6 or 7, wherein the indication of the power amplifier backoff adaptation pattern indicates at least one power amplifier backoff adaptation value associated with the power amplifier backoff adaptation.

Aspect 9: The method of any of Aspects 6-8, wherein the indication of the power amplifier backoff adaptation pattern indicates at least one beam associated with the power amplifier backoff adaptation pattern.

Aspect 10: The method of any of Aspects 2-9, wherein the resource status request communication indicates at least one beam associated with the power amplifier backoff adaptation.

Aspect 11: The method of any of Aspects 1-10, wherein the resource status information indicates an acceptance by the second network node that is associated with the power amplifier backoff adaptation.

Aspect 12: The method of Aspect 11, wherein the resource status information indicates at least one beam associated with the acceptance.

Aspect 13: The method of either of claim 11 or 12, wherein the resource status information indicates at least one beam associated with a rejection by the second network node that is associated with the power amplifier backoff adaptation.

Aspect 14: The method of any of Aspects 11-13, wherein the resource status information indicates a cell deactivation associated with a duration associated with the power amplifier backoff adaptation.

Aspect 15: The method of any of Aspects 1-14, further comprising receiving additional resource status information associated with at least one additional network node, wherein performing the power amplifier backoff adaptation comprises performing the power amplifier backoff adaptation based on the additional resource status information.

Aspect 16: A method of wireless communication performed by a second network node, comprising: detecting an occurrence of a trigger condition for providing resource status information associated with a power amplifier backoff adaptation corresponding to a first network node; and transmitting the resource status information based on the occurrence of the trigger condition.

Aspect 17: The method of Aspect 16, wherein detecting the occurrence of the trigger condition comprises receiving a resource status request communication.

Aspect 18: The method of Aspect 17, wherein the resource status request communication comprises an indication associated with the power amplifier backoff adaptation.

Aspect 19: The method of either of Aspects 17 or 18, wherein the resource status request communication indicates a time period corresponding to the power amplifier backoff adaptation.

Aspect 20: The method of any of Aspects 17-19, wherein the resource status request communication indicates at least one time resource corresponding to the power amplifier backoff adaptation.

Aspect 21: The method of any of Aspects 17-20, wherein the resource status request communication comprises an indication of a power amplifier backoff adaptation pattern associated with the power amplifier backoff adaptation.

Aspect 22: The method of Aspect 21, wherein the indication of the power amplifier backoff adaptation pattern indicates a plurality of time resources associated with the power amplifier backoff adaptation.

Aspect 23: The method of either of claim 21 or 22, wherein the indication of the power amplifier backoff adaptation pattern indicates at least one power amplifier backoff adaptation value associated with the power amplifier backoff adaptation.

Aspect 24: The method of any of Aspects 21-23, wherein the indication of the power amplifier backoff adaptation pattern indicates at least one beam associated with the power amplifier backoff adaptation pattern.

Aspect 25: The method of any of Aspects 17-24, wherein the resource status request communication indicates at least one beam associated with the power amplifier backoff adaptation.

Aspect 26: The method of any of Aspects 16-25, wherein the resource status information indicates an acceptance by the second network node that is associated with the power amplifier backoff adaptation.

Aspect 27: The method of Aspect 26, wherein the resource status information indicates at least one beam associated with the acceptance.

Aspect 28: The method of Aspect 27, wherein the resource status information indicates the at least one beam based on detecting that no user equipment is in connected status with the at least one beam.

Aspect 29: The method of either of Aspects 27 or 28, further comprising deactivating at least one cell associated with the at least one beam for a duration associated with the power amplifier backoff adaptation.

Aspect 30: The method of Aspect 29, wherein the resource status information indicates a cell deactivation associated with the at least one cell for the duration.

Aspect 31: The method of any of Aspects 26-30, wherein the resource status information indicates at least one beam associated with a rejection by the second network node that is associated with the power amplifier backoff adaptation.

Aspect 32: The method of any of Aspects 16-31, further comprising refraining from scheduling a downlink communication corresponding to a beam associated with the power amplifier backoff adaptation.

Aspect 33: The method of any of Aspects 16-32, further comprising refraining from scheduling a downlink communication corresponding to a user equipment that is susceptible to interference associated with the power amplifier backoff adaptation.

Aspect 34: The method of any of Aspects 16-33, wherein detecting the occurrence of the trigger condition comprises detecting that no user equipment is connected to a cell that is susceptible to interference associated with the power amplifier backoff adaptation.

Aspect 35: The method of any of Aspects 16-34, wherein detecting the occurrence of the trigger condition comprises detecting deactivation of a cell that is susceptible to interference associated with the power amplifier backoff adaptation.

Aspect 37: The method of either of Aspects 6, 7, 21, or 22, wherein the indication of the power amplifier backoff adaptation pattern indicates power amplifier backoff adaptation information associated with at least one time resource position of a set of time resource positions, wherein the set of time resource positions comprises a pattern to be applied to at least one set of time resources.

Aspect 38: The method of any of Aspects 1-15, wherein performing the power backoff adaptation comprises reducing a power amplifier backoff associated with a power amplifier of the first network node.

Aspect 39: An apparatus for wireless communication at a device, comprising a processor; memory coupled with the processor; and instructions stored in the memory and executable by the processor to cause the apparatus to perform the method of one or more of Aspects 1-15, 37, or 38.

Aspect 40: A device for wireless communication, comprising one or more memories and one or more processors coupled to the one or more memories, the one or more processors individually or collectively configured to perform the method of one or more of Aspects 1-15, 37, or 38.

Aspect 41: An apparatus for wireless communication, comprising at least one means for performing the method of one or more of Aspects 1-15, 37, or 38.

Aspect 42: A non-transitory computer-readable medium storing code for wireless communication, the code comprising instructions executable by a processor to perform the method of one or more of Aspects 1-15, 37, or 38.

Aspect 43: A non-transitory computer-readable medium storing a set of instructions for wireless communication, the set of instructions comprising one or more instructions that, when executed by one or more processors of a device, cause the device to perform the method of one or more of Aspects 1-15, 37, or 38.

Aspect 44: An apparatus for wireless communication at a device, comprising a processor; memory coupled with the processor; and instructions stored in the memory and executable by the processor to cause the apparatus to perform the method of one or more of Aspects 16-35 or 37.

Aspect 45: A device for wireless communication, comprising one or more memories and one or more processors coupled to the one or more memories, the one or more processors individually or collectively configured to perform the method of one or more of Aspects 16-35 or 37.

Aspect 46: An apparatus for wireless communication, comprising at least one means for performing the method of one or more of Aspects 16-35 or 37.

Aspect 47: A non-transitory computer-readable medium storing code for wireless communication, the code comprising instructions executable by a processor to perform the method of one or more of Aspects 16-35 or 37.

Aspect 48: A non-transitory computer-readable medium storing a set of instructions for wireless communication, the set of instructions comprising one or more instructions that, when executed by one or more processors of a device, cause the device to perform the method of one or more of Aspects 16-35 or 37.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A first network node for wireless communication, comprising:
one or more memories; and
one or more processors coupled to the one or more memories, the one or more processors individually or collectively configured to cause the first network node to:
receive resource status information associated with a second network node; and
perform a power amplifier backoff adaptation based on the resource status information.

2. The first network node of claim 1, wherein the one or more processors are further individually or collectively configured to cause the first network node to transmit a resource status request communication, wherein the one or more processors are individually or collectively configured to receive the resource status information based on the resource status request communication.

3. The first network node of claim 2, wherein the resource status request communication comprises an indication associated with the power amplifier backoff adaptation.

4. The first network node of claim 2, wherein the resource status request communication indicates a time period corresponding to the power amplifier backoff adaptation.

5. The first network node of claim 2, wherein the resource status request communication indicates at least one time resource corresponding to the power amplifier backoff adaptation.

6. The first network node of claim 2, wherein the resource status request communication comprises an indication of a power amplifier backoff adaptation pattern associated with the power amplifier backoff adaptation.

7. The first network node of claim 6, wherein the indication of the power amplifier backoff adaptation pattern indicates a plurality of time resources associated with the power amplifier backoff adaptation.

8. The first network node of claim 6, wherein the indication of the power amplifier backoff adaptation pattern indicates power amplifier backoff adaptation information associated with at least one time resource position of a set of time resource positions, wherein the set of time resource positions comprises a pattern to be applied to at least one set of time resources.

9. The first network node of claim 6, wherein the indication of the power amplifier backoff adaptation pattern indicates at least one power amplifier backoff adaptation value associated with the power amplifier backoff adaptation.

10. The first network node of claim 6, wherein the indication of the power amplifier backoff adaptation pattern indicates at least one beam associated with the power amplifier backoff adaptation pattern.

11. The first network node of claim 2, wherein the resource status request communication indicates at least one beam associated with the power amplifier backoff adaptation.

12. The first network node of claim 1, wherein the resource status information indicates an acceptance by the second network node that is associated with the power amplifier backoff adaptation.

13. The first network node of claim 12, wherein the resource status information indicates at least one beam associated with the acceptance.

14. The first network node of claim 12, wherein the resource status information indicates at least one beam associated with a rejection by the second network node that is associated with the power amplifier backoff adaptation.

15. The first network node of claim 12, wherein the resource status information indicates a cell deactivation associated with a duration associated with the power amplifier backoff adaptation.

16. The first network node of claim 1, wherein the one or more processors are further individually or collectively configured to cause the first network node to receive additional resource status information associated with at least one additional network node, wherein the one or more processors, to cause the first network node to perform the power amplifier backoff adaptation, are individually or collectively configured to cause the first network node to perform the power amplifier backoff adaptation based on the additional resource status information.

17. The first network node of claim 1, wherein the one or more processors, to perform the power backoff adaptation, are individually or collectively configured to cause the first network node to reduce a power amplifier backoff associated with a power amplifier of the first network node.

18. A second network node for wireless communication, comprising:
one or more memories; and
one or more processors coupled to the one or more memories, the one or more processors individually or collectively configured to cause the second network node to:
detect an occurrence of a trigger condition for providing resource status information associated with a power amplifier backoff adaptation corresponding to a first network node; and
transmit the resource status information based on the occurrence of the trigger condition.

19. The second network node of claim 18, wherein the one or more processors, to cause the second network node to detect the occurrence of the trigger condition, are individually or collectively configured to cause the second network node to receive a resource status request communication.

20. The second network node of claim 19, wherein the resource status request communication comprises at least one of an indication associated with the power amplifier backoff adaptation or an indication of a power amplifier backoff adaptation pattern associated with the power amplifier backoff adaptation.

21. The second network node of claim 19, wherein the resource status request communication indicates at least one of a time period corresponding to the power amplifier backoff adaptation, a time resource corresponding to the power amplifier backoff adaptation, a beam associated with the power amplifier backoff adaptation.

22. The second network node of claim 18, wherein the resource status information indicates an acceptance by the second network node that is associated with the power amplifier backoff adaptation.

23. The second network node of claim 18, wherein the one or more processors are further individually or collectively configured to cause the second network node to refrain from scheduling a downlink communication corresponding to a beam associated with the power amplifier backoff adaptation.

24. The second network node of claim 18, wherein the one or more processors are further individually or collectively configured to cause the second network node to refrain from scheduling a downlink communication corresponding to a user equipment that is susceptible to interference associated with the power amplifier backoff adaptation.

25. The second network node of claim 18, wherein the one or more processors, to cause the second network node to detect the occurrence of the trigger condition, are individually or collectively configured to cause the second network node to detect that no user equipment is connected to a cell that is susceptible to interference associated with the power amplifier backoff adaptation.

26. The second network node of claim 18, wherein the one or more processors, to cause the second network node to detect the occurrence of the trigger condition, are individually or collectively configured to cause the second network node to detect deactivation of a cell that is susceptible to interference associated with the power amplifier backoff adaptation.

27. A method of wireless communication performed by a first network node, comprising:
receiving resource status information associated with a second network node; and
performing a power amplifier backoff adaptation based on the resource status information.

28. The method of claim 27, further comprising transmitting a resource status request communication, wherein receiving the resource status information comprises receiving the resource status information based on the resource status request communication.

29. A method of wireless communication performed by a second network node, comprising:
detecting an occurrence of a trigger condition for providing resource status information associated with a power amplifier backoff adaptation corresponding to a first network node; and
transmitting the resource status information based on the occurrence of the trigger condition.

30. The method of claim 29, wherein detecting the occurrence of the trigger condition comprises receiving a resource status request communication.
